(19) United States
(12) Patent Application Publication
(10) Pub. No.: US 2014/0279712 A1
(43) Pub. Date: Sep. 18, 2014

(54) UTILITY MONITORING AND BILLING SYSTEMS, AND METHODS

(71) Applicant: American Metering Services, Inc., Sarasota, FL (US)

(72) Inventor: Matthew Ortner, North Point, FL (US)

(73) Assignee: American Metering Services, Inc., Sarasota, FL (US)

(21) Appl. No.: 14/215,400

(22) Filed: Mar. 17, 2014

Related U.S. Application Data
(60) Provisional application No. 61/787,882, filed on Mar. 15, 2013.

(51) Int. Cl. G06Q 30/02; G06Q 50/06; G06Q 30/04

(52) U.S. Cl. CPC G06Q 30/0283; G06Q 30/04; G06Q 50/06
USPC 705/412

(57) ABSTRACT

Methods and systems using the method of calculating and charging for utility usage are disclosed. The method comprises the steps of, on a processing unit, obtaining a utility bill from a utility company for a multi-unit property, obtaining a reading from at least one submeter monitoring the usage of the utility for each unit of the multi-unit property, totaling the submetered usage, calculating a percent usage of the utility for each unit, calculating a charge for each unit based on the percentage usage for each unit, and billing each unit for the charge calculated for that unit.

### REFERENCE TO RELATED APPLICATIONS

This application claims priority to U.S. Provisional Application No. 61/787,882, filed Mar. 15, 2013, entitled “Utility Monitoring and Billing Systems, and Methods,” and is hereby specifically and entirely incorporated by reference.

### BACKGROUND

1. Field of the Invention

The invention is directed to systems, and methods of monitoring and billing utilities such as, but not limited to the supply and use of commercial, industrial or residential water, sewage, HVAC, gas and/or electricity.

2. Background of the Invention

Building management companies, landlords, property management firms, condominium associations, homeowners associations, or other multi-tenant property managers (hereinafter “landlord”) administer numerous utility systems within each of their multi-unit properties (e.g. condominiums, offices, and shopping centers). Such systems are usually complex infrastructures and include but are not limited to water distribution, gas distribution, electricity distribution, waste management, and HVAC supply. Each of these systems may be monitored for use and billed to the tenants.

Traditionally, the landlords, would factor in the use of the utilities into each tenant's rent. However, many states have enacted laws allowing the landlords to directly bill the tenants for their utility usage. Two main billing methods are used in common practice.

The first billing method involves a ratio utility billing system (RUBS). Under a RUBS, the actual utility bill for the property is distributed to each tenant based on an allocation formula. Factors in the formula can include one or a combination of the number of occupants, the square footage, the number of bathrooms, number of water fixtures, or another unit of measure. Such a distribution of the utility bill, however, benefits tenants who use a lot of the utility and determents tenants who do not use the utility often (e.g. people who are out of town and, therefore, do not use any in a particular month).

The second billing method, submetering, is the implementation of a system that allows a landlord to bill tenants for individual measured utility usage. The approach makes use of individual water meters, gas meters, electricity meters or other utility meter attached to the tenant's unit. However, there are a number of issues with this method. For example, submeters generally have an accuracy variance that diminishes over time, usually resulting in underreading the actual usage. This will cause less of the utility to be accounted for than what was actually consumed. Even if the submeters were 100% accurate, each submeter would have to be read (have the current flow tally recorded) at the exact same moment as the corresponding master (public utility) meter in order to account properly for the amount of water consumed during the same period of time, as tallied by the utility company. There are often plumbing issues, such as leaks, or even unmetered points of access on the private side of the master (public utility) meter, meaning that some water used for the benefit of the property is not fully accounted for, and yet in most (if not all) states and cities, the property is allowed to collect the entire amount of the water bill from the residents.

### SUMMARY OF THE INVENTION

The present invention overcomes the problems and disadvantages associated with current strategies and systems and provides new systems and methods of monitoring and billing utilities.

An embodiment of the invention is directed to a method of calculating utility usage. The method comprises the steps of, on a processor, obtaining a utility bill from a utility company for a multi-unit property, obtaining a reading from at least one submeter monitoring the usage of the utility for each unit of the multi-unit property, totaling the submetered usage, calculating a percent usage of the utility for each unit, calculating a charge for each unit based on the percentage usage for each unit, and outputting for each unit the charge calculated for that unit.

Preferably, the utility is at least one of water, sewage, gas, electricity, HVAC, and combinations thereof. In a preferred embodiment, the method further comprises determining the amount of common usage of the utility and factoring in the amount of common usage of the utility in the percent usage calculations. Preferably, the submeters are read automatically and are in wireless communication with the processing unit. In a preferred embodiment, the submeters are read at the time the utility bill is received or are read continuously and usage data is stored in a database. The multi-unit property is preferably a building with multiple units.

Another embodiment of the invention is directed to a system for calculating utility usage in a multi-unit property. The system comprises a plurality of submeters, each submeter monitoring the usage of at least one utility for each unit, a central processing unit in communication with each submeter, and software executing on the central processing unit. The software obtains a utility bill from a utility company for a multi-unit property, obtains a reading from each submeter, totals the submetered usage, calculates a percent usage of the utility for each unit, calculates a charge for each unit based on the percentage usage for each unit, and outputs for each unit the charge calculated for that unit.

In a preferred embodiment, the utility is at least one of water, sewage, gas, electricity, HVAC, and combinations thereof. Preferably, the software determines the amount of common usage of the utility and factors in the amount of common usage of the utility in the percent usage calculations. Preferably, the submeters are read automatically and are in wireless communication with the processing unit. The submeters are preferably read at the time the utility bill is received or are read continuously and the usage data is stored in a database. Preferably, the multi-unit property is a building with multiple units.

Other embodiments and advantages of the invention are set forth in part in the description, which follows, and in part, may be obvious from this description, or may be learned from the practice of the invention.

### DESCRIPTION OF THE DRAWINGS

The invention is described in greater detail by way of example only and with reference to the attached drawings, in which:

FIG. 1 is a schematic of one embodiment of the system of the invention.

FIG. 2 an example of a multi-unit building.

FIG. 3 is an embodiment of a submeter.

FIG. 4 is a flowchart of an embodiment of a method of the invention.

### DESCRIPTION OF THE INVENTION

As embodied and broadly described herein, the disclosures herein provide detailed embodiments of the invention. However, the disclosed embodiments are merely exemplary of the invention that may be embodied in various and alternative forms. Therefore, there is no intent that specific structural and functional details should be limiting, but rather the intention is that they provide a basis for the claims and as a representative basis for teaching one skilled in the art to variously employ the present invention.

A problem in the art capable of being solved by the embodiments of the present invention is monitoring and billing utilities in multi-unit properties. It has surprisingly been discovered that a combination of submetering and ratio billing can be employed to fairly recover the full costs of the utility usage.

With reference to FIG. 1, an exemplary system includes at least one general-purpose computing device 100, including a processing unit (CPU) 120 and a system bus 110 that couples various system components including the system memory such as read only memory (ROM) 140 and random access memory (RAM) 150 to the processing unit 120. Other system memory 130 may be available for use as well. It can be appreciated that the invention may operate on a computing device with more than one CPU 120 or on a group or cluster of computing devices networked together to provide greater processing capability. The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices such as a hard disk drive 160, a magnetic disk drive, an optical disk drive, tape drive or the like. The storage device 160 is connected to the system bus 110 by a drive interface. The drives and the associated computer readable media provide nonvolatile storage of computer readable instructions, data structures, program modules and other data for the computing device 100. The basic components are known to those of skill in the art and appropriate variations are contemplated depending on the type of device, such as whether the device is a small, handheld computing device, a desktop computer, a computer server, a handheld scanning device, or a wireless devices, including wireless Personal Digital Assistants (“PDAs”) (e.g., Microsoft's Windows, Research in Motion's Blackberry™, an Android™ device, Apple's iPhone™), tablet devices (e.g., Amazon's Kindle™, Apple's iPad™), wireless web-enabled phones, other wireless phones, etc.

Although the exemplary environment described herein employs the hard disk, it should be appreciated by those skilled in the art that other types of computer readable media which can store data that are accessible by a computer, such as magnetic cassettes, flash memory cards, digital versatile disks, cartridges, random access memories (RAMs), read only memory (ROM), a cable or wireless signal containing a bit stream and the like, may also be used in the exemplary operating environment.

To enable user interaction with the computing device 100, an input device 190 represents any number of input mechanisms, such as a microphone for speech, a touch-sensitive screen for gesture or graphical input, keyboard, mouse, motion input, speech and so forth. The device output 170 can be one or more of a number of output mechanisms known to those of skill in the art, for example, printers, monitors, projectors, speakers, and plotters. In some embodiments, the output can be via a network interface, for example uploading to a website, emailing, attached to or placed within other electronic files, and sending an SMS or MMS message. In some instances, multimodal systems enable a user to provide multiple types of input to communicate with the computing device 100. The communications interface 180 generally governs and manages the user input and system output. There is no restriction on the invention operating on any particular hardware arrangement and therefore the basic features here may easily be substituted for improved hardware or firmware arrangements as they are developed.

For clarity of explanation, the illustrative system embodiment is presented as comprising individual functional blocks (including functional blocks labeled as a “processor”). The functions these blocks represent may be provided through the use of either shared or dedicated hardware, including, but not limited to, hardware capable of executing software. For example the functions of one or more processors presented in FIG. 1 may be provided by a single shared processor or multiple processors. (Use of the term “processor” should not be construed to refer exclusively to hardware capable of executing software.) Illustrative embodiments may comprise microprocessor and/or digital signal processor (DSP) hardware, read-only memory (ROM) for storing software performing the operations discussed below, and random access memory (RAM) for storing results. Very large scale integration (VLSI) hardware embodiments, as well as custom VLSI circuitry in combination with a general purpose DSP circuit, may also be provided.

Embodiments within the scope of the present invention may also include computer-readable media (or software) for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like. Networks may include the Internet, one or more Local Area Networks (“LANs”), one or more Metropolitan Area Networks (“MANs”), one or more Wide Area Networks (“WANs”), one or more Intranets, etc. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

FIG. 2 depicts an example of a multi-tenant building 200. While a single building with multiple tenants is used in the example, the invention can be used for multi-building properties, each single tenant or multi-tenant. In the figure, each unit is represented by a box. As shown in FIG. 2, for example, the building may have 10 units 201-210, however a building can have more or less units. In the preferred embodiment, each unit has at least one utility submeter 201s-210s. Each submeter may track the unit's water usage, electricity usage, sewer usage, HVAC usage, other fluid usage, or other utility provided by the building. In the example shown in FIG. 2, the submetering will be described with reference to water usage.

In the preferred embodiment, each submeter is preferably positioned between the building's water infrastructure and the associated unit's water infrasturcutre. The water infrastructure includes, but is not limited to, the faucets, toilets, water using appliances, and other water using devices. In other embodiments, certain aspects of a unit's water infrastructure may not be monitored by the submeter.

The network of submeters 201s-210s is capable of providing a landlord with a full picture of the current state of the system. Each submeter may be capable of sending and receiving data to and from at least one operations center. Communication may be from each submeter to a central monitoring facility, to one of a number of regional monitoring centers, and/or to a user. Communication is preferably over the Internet, but may be over a private network, a local area network, or a wide area network. Preferably the communication involves a wireless component, such as from the remote monitoring device and/or control device to a regional monitoring facility, or to distributed monitors. Also preferably, the communications are secured or encrypted such that the communications system cannot be monitored by another, unknown party. Preferably access to the system is granted through user names and passwords, although additional and/or alternate encryption methods can be employed.

Communication can occur over communications networks known in the art, including but not limited to wired networks, wireless networks, Zigbee networks, Bluetooth networks, Z-wave networks, WiFi networks, WiMax networks, RF networks, local area networks (LAN), internet networks, wide area networks (WAN), cellular telephone network, hardwired telephone networks, 900 MHz wireless networks, and satellite networks. In the preferred embodiment, the network is a fixed network. For example, the fixed network can be a mesh network or a star network. Additionally, the submeters 201s-210s and a central processing unit can be in direct communication or can communicate through an intermediary device, such as a relay, a repeater, a gateway, or other device capable of receiving and retransmitting a message.

Each submeter 201s-210s may additionally be able to report problems in the system. For example, if a submeter detects a drop in water pressure, a water leak can be reported using the network. In the preferred embodiment, the submeters 201s-210s can be self monitoring. For example the submeters can preferably determine if there is a loss of communication, low battery levels, and/or internal damage (e.g. short circuits due to water damage).

In preferred embodiments, each submeter 201s-210s is assigned a unique identifier. The unique identifier can be related to the devices' geographical locations, street addresses, order of installation, or any other method of identifying the devices. Furthermore, different types of submeters 201s-210s can have identifiers that are unique to that type of device. For example, the identifier for water meters can start with a WM, while the identifier for gas meters can start with a GM. Each communication to and from each submeter 201s-210s can include the unique identifier so that the message is received by the correct submeter 201s-210s, or the central processing unit can determine where the message was sent from.

The central processing unit can be located at the landlord's office, a municipality office, a private or public company, or any other entity that monitors the submeters 201s-210s. In other embodiments, the central processing unit can be a remotely hosted operations center accessible by a device capable of accessing the Internet. In such embodiments, the central processing unit can take advantage of cloud computing (e.g. a network of remotely hosted computers, servers, and data storage devices). Compared to non-remotely hosted computer networks, cloud computing can increase ease of use, increase access, increase security, decrease costs, be custom tailored, and provide an unrestricted expansion of storage space. Additionally, in preferred embodiments, there may be a plurality of central processing unit. The central processing unit, in preferred embodiments, can send transmissions to update the firmware of submeters 201s-210s.

FIG. 3 is a schematic of a submeter 300. Submeter 300 includes a processor 305. Processor 305 is coupled to at least one input port 310 for receiving data from a sensor 315. Processor 305 is also coupled to a transceiver 320 for sending and receiving signals. In preferred embodiments, processor 305 is coupled to a data storage unit 330. Data storage unit 330 can hold a predetermined amount of data received from the sensors 315. For example, data storage unit 330 can hold data for a predetermined amount of time (e.g. one day, one week, or one month), can hold a predetermined number of readings (e.g. 10 readings, 100 readings, 1000 readings), or can hold data until directed to purge the data by the central processing unit. Additionally, data storage unit 330 can hold instructions for processor 305 to execute upon prompting from the operations center. In the preferred embodiments, processor 305 compiles at least some of the data stored in data storage unit 330 for transmitting to the operations center.

Each remote monitoring device 300 may collect data and/or transmit data continuously, at specific intervals, or randomly. In embodiments where the monitoring device 300 collects and transmits data in a non-continuous configuration, monitoring device 300 may turn off or reduce power consumption during the non-data collecting periods to save energy. In preferred embodiments, processor 305 is coupled to a power source 335. Power source 335 can be a device capable of powering processor 305 and devices attached to processor 305. For example, power source 335 can be a battery, solar panel array, wind turbine, water turbine, electrical lines, or combinations thereof. In preferred embodiments, there is also a backup power source, such as a battery. In preferred embodiments, the power may derive from the operation of the infrastructure system.

In the preferred embodiment, processor 305 is coupled to at least one sensor 315 that monitors at least one condition associated with the submeter. In preferred embodiments, sensors 315 can determine the status of a device. Sensors 315 can be directly wired to processor 305 or can use wireless communication to send and receive signals from processor 305. Sensors 315 can be positioned within the sub meter or be external to the submeter. In the embodiments, where sensors 215 and processor 205 communicate wirelessly, the same communications protocol can be used in the sensor/processor communication as in the processor/central processing unit communication, or different communications protocols can be used in the sensor/processor communication as in the processor/central processing unit communication. For example, the sensor/processor communications can use RF protocols while the processor/control center communications can be over a wired network.

In preferred embodiments, sensor 315 is a use monitor. In such embodiments, the use monitor records the amount of water, gas, electricity, or other commodity that is used by a customer over a specified period of time. The use monitor can continuously record the amount of the commodity used or the use monitor can provide a signal to processor 305 that the commodity is in use. Processor 305 can transmit a signal to the operations control to alert the central processing unit that the submeter is being used and/or how much of the commodity is flowing through the sensor. In preferred embodiments, the central processing unit can request a reading from the use monitor on demand. In preferred embodiments, the processor or the central processing unit can determine based on the use, if there is unauthorized use of the commodity. Upon detection of unauthorized use, at least one of processor 305 or the central processing unit can generate an alarm that there is unauthorized use.

FIG. 4 is a flow chart showing an embodiment of a method 400 of billing for the utility usage. At regular intervals (usually once a month), the landlord receives a bill from the utility company for the property's usage of the commodity 405. The landlord then obtains the usage for each submetered unit 410. The landlord can obtain the usage from each submeter directly from the submeter or from a database of recorded usage. The landlord preferably totals the usage from all of the submeters 415 and determines the percent usage for each unit 420. For example, if each submetered usage is Uᵢ, for n units, then the total submetered usage, Uₜ, is:

$${U}_{t} = {\sum }_{i = 1}^{n} {U}_{i}$$

Then, the percentage usage, Pᵢ, for each unit can be calculated by:

$${P}_{i} = \frac{{U}_{i}}{{U}_{t}}$$

Based on the percent usage of each unit, the landlord can charge each unit based on their share of the total submetered usage 425.

In the preferred embodiment, the landlord may also take into consideration any common usage of the utility (e.g. in common bathrooms, pools, and laundry rooms). The landlord may pay for the common usage him/herself or may allot the common usage to the tenants based on each unit's calculated percentage.

### EXAMPLE

Table 1 shows an example of the calculations described herein. In the example, the water company charged the building for 10,000 gallons of water at $0.10 a gallon, for a total bill of $1000.00. The total usage as determined by the submeters attached to the six units is 9170 gallons. Therefore 830 gallons, or $83.00 worth of water, is unaccounted for. Under traditional subetered billing, were each unit pays only for the utility usage measured by the submeter, the landlord would have to pay for the remaining $83.00. However, using the billing method described herein, where the percentage share of each unit is calculated and then applied to the total bill, the landlord can pass the entire bill onto the tenants, fairly recovering 100% of the expenses.

TABLE 1

| Utility Bill Usage: | | 10,000.00 | Gallons | |
|---|---|---|---|---|
| Utility Bill Charges: | | $1,000.00 | | |
| Cost Per Gallon: | | $0.10 | | |
| | | | Charges | |
| Unit | Usage | Share | Traditional | Inventive |
| 101 | 1920 | 21% | $192.00 | $209.38 |
| 102 | 1710 | 19% | $171.00 | $186.48 |
| 103 | 1260 | 14% | $126.00 | $137.40 |
| 201 | 2080 | 23% | $208.00 | $226.83 |
| 202 | 1160 | 13% | $116.00 | $126.50 |
| 203 | 1040 | 11% | $104.00 | $113.41 |
| Total: | 9170 | 100% | $917.00 | $1,000.00 |

In addition, the method loads each public utility bill each month, with line level detail, to ensure that the landlord is receiving the proper charges for each period. For those properties that go with the traditional method, this ensures that they utility price per gallon is determined each month, and that the residents are charged the actual price per gallon that the property is billed, regardless of the public utility tier calculations and overall usage vs. individual usage.

Other embodiments and uses of the invention will be apparent to those skilled in the art from consideration of the specification and practice of the invention disclosed herein. All references cited herein, including all publications, U.S. and foreign patents and patent applications, are specifically and entirely incorporated by reference. It is intended that the specification and examples be considered exemplary only with the true scope and spirit of the invention indicated by the following claims. Furthermore, the term “comprising of” includes the terms “consisting of” and “consisting essentially of.” All examples illustrate embodiments of the invention, but should not be viewed as limiting the scope of the invention.

1. A method of calculating utility usage, comprising the steps of, on a processing unit:
obtaining a utility bill from a utility company for a multi-unit property;
obtaining a reading from at least one submeter monitoring the usage of the utility for each unit of the multi-unit property;
totaling the submetered usage;
calculating a percent usage of the utility for each unit;
calculating a charge for each unit based on the percentage usage for each unit; and
outputting for each unit the charge calculated for that unit.

2. The method of claim 1, wherein the utility is at least one of water, sewage, gas, electricity, HVAC, and combinations thereof.

3. The method of claim 1, further comprising determining the amount of common usage of the utility and factoring in the amount of common usage of the utility in the percent usage calculations.

4. The method of claim 1, wherein the submeters are read automatically.

5. The method of claim 1, wherein the submeters are in wireless communication with the processing unit.

6. The method of claim 1, wherein the submeters are read at the time the utility bill is received.

7. The method of claim 1, wherein the submeteres are read continuously and usage data is stored in a database.

8. The method of claim 1, wherein the multi-unit property is a building with multiple units.

9. A system for calculating utility usage in a multi-unit property, comprising:
a plurality of submeters, each submeter monitoring the usage of at least one utility for each unit;
a central processing unit in communication with each submeter;
software executing on the central processing unit, wherein the software:
obtains a utility bill from a utility company for a multi-unit property;
obtains a reading from each submeter;
totals the submetered usage;
calculates a percent usage of the utility for each unit;
calculates a charge for each unit based on the percentage usage for each unit; and
outputs for each unit the charge calculated for that unit.

10. The system of claim 9, wherein the utility is at least one of water, sewage, gas, electricity, HVAC, and combinations thereof.

11. The system of claim 9, wherein the software determines the amount of common usage of the utility and factors in the amount of common usage of the utility in the percent usage calculations.

12. The system of claim 9, wherein the submeters are read automatically.

13. The system of claim 9, wherein the submeters are in wireless communication with the processing unit.

14. The system of claim 9, wherein the submeters are read at the time the utility bill is received.

15. The system of claim 9, wherein the submeteres are read continuously and usage data is stored in a database.

16. The system of claim 9, wherein the multi-unit property is a building with multiple units.
